(19) United States
(12) Patent Application Publication
(10) Pub. No.: US 2008/0223648 A1
(43) Pub. Date: Sep. 18, 2008

(54) Body Frame of Motorcycle, Assembling Method of Mounting Engine on Body Frame, and Motorcycle Having Body Frame

(75) Inventor: Takushirou SHIRAISHI, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/047,177

(22) Filed: Mar. 12, 2008

(30) Foreign Application Priority Data
Mar. 13, 2007 (JP) 2007-064197

(51) Int. Cl. B62K 11/04; B62K 11/02

(52) U.S. Cl. 180/312; 180/311

(57) ABSTRACT

A body frame of a motorcycle in which strength and rigidity against external forces are secured while increased cost is suppressed. A mainframe has an upper bearing and a pipe main body of a head pipe and is extended rearward. A down tube includes a first tube having a lower bearing of the head pipe and extended rearward and second tubes joining the first tube and bosses of the mainframe. The first tube is joined to the mainframe by welding, and the second tubes are detachably joined to the first tube.

### RELATED APPLICATIONS

This application claims the benefit of priority under 35 USC 119 of Japanese patent application no. 2007-064197, filed on Mar. 13, 2007, which application is hereby incorporated by reference in its entirety.

### BACKGROUND OF THE INVENTION

1. Field of the Invention

The present invention relates to a body frame of a motorcycle including a mainframe and a down tube extending in a rear direction from a head pipe.

2. Description of Related Art

A motorcycle, such as an off-road type motorcycle used for a motocross race, may be driven on a rough course or used for a jump. Accordingly, it is desirable to reduce weight while securing strength and rigidity of the body frame against impact when driving and landing on a rough course.

For example, in JP-A-2007-8434, a lower part of a head pipe and a connecting part with a down tube are made by forged aluminum alloy; and an upper part of the head pipe, a mainframe, and the rest of the down tube are made by casted aluminum alloy.

In general, a cast part is less expandable and less viscous against external force than a forged part. Therefore, in this structure, the strength and rigidity of the cast part of the down tube may be insufficient. For example, a crack may be caused in the cast part of the down tube due to impact force when landing after a jump or the like.

The whole part from the lower part of the head pipe to the down tube may be constituted by forged parts in order to increase strength and rigidity against external forces. However, such constitution has a drawback in increased manufacturing and material costs, including an increased cost of welding.

### SUMMARY OF THE INVENTION

The present invention addresses these drawbacks and provides a body frame of a motorcycle in which strength and rigidity against external forces and increased cost is suppressed.

The present invention is a body frame of a motorcycle. A mainframe is extended rearward from a head pipe; and a down tube positioned under the mainframe is extended rearward from the head pipe and joined to a rear end of the mainframe. The mainframe comprises a first section of the head pipe and is extended rearward. The down tube includes a first tube constituting a second section of the head pipe and extended rearward; and a second tube joining the first tube and the rear end of the mainframe. The first tube is joined to the mainframe by welding, and the second tubes are detachably joined to the first tube.

In the body frame according to the present invention, the mainframe constitutes the first section of the head pipe and is extended rearward, and the down tube includes the first tube constituting the second section of the head pipe and extended rearward and the second tube detachably joined to the first tube. Consequently, the first tube to which a maximum impact force from a road is applied and the mainframe to which a relatively small impact force is applied are constituted by a part corresponding to each impact force. In one embodiment, the first tube is made with a forged part and the mainframe is made with a cast part, so that strength and rigidity of the body frame against an input from a road surface is secured, and increased cost is suppressed.

In addition, since the second tube is detachable from the first tube, material for the second tube can be freely selected. Therefore, in one embodiment, necessary strength and rigidity is secured and material cost suppressed by adopting an iron part.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a side view of a motorcycle according to one embodiment of the present invention.

FIG. 2 is a side view of a body frame of the motorcycle.

FIG. 3 is side view of a mainframe of the body frame.

FIG. 4 is a plan view of the mainframe.

FIG. 5 is a front view of the mainframe.

FIG. 6 is a front view of a down tube of the body frame.

FIG. 7 is a plan view of the down tube.

FIG. 8 is a cross-sectional view taken along line VIII-VIII of FIG. 2.

FIG. 9 is a cross-sectional view taken along line IX-IX of FIG. 2.

FIG. 10 is a cross-sectional view taken along line X-X of FIG. 2.

FIG. 11 is a cross-sectional view taken along line XI-XI of FIG. 2.

FIG. 12 is a cross-sectional view taken along line XII-XII of FIG. 2.

FIG. 13 is a cross-sectional view taken along line XIII-XIII of FIG. 2.

FIG. 14 is a perspective view of a stand bracket of the body frame.

FIG. 15 is a perspective view of an extra recess of the body frame.

FIG. 16 is a perspective view of an extra recess of the body frame.

### DETAILED DESCRIPTION OF THE INVENTION

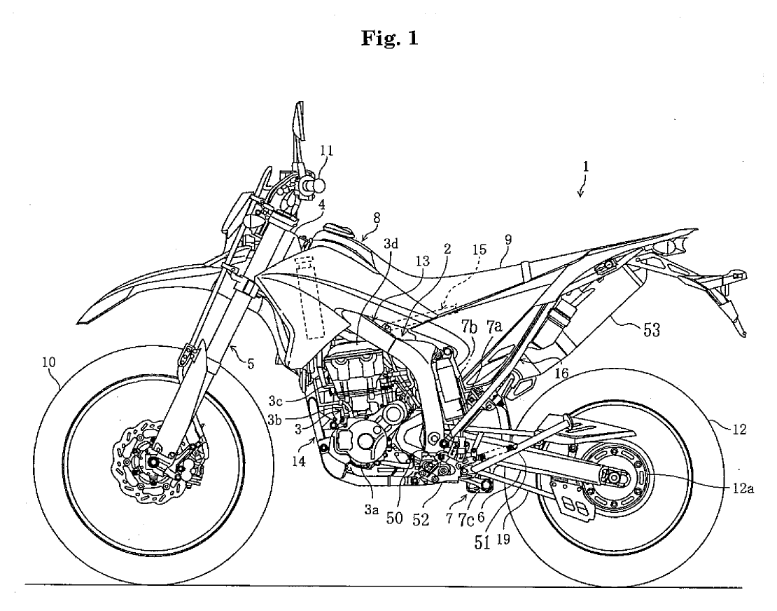

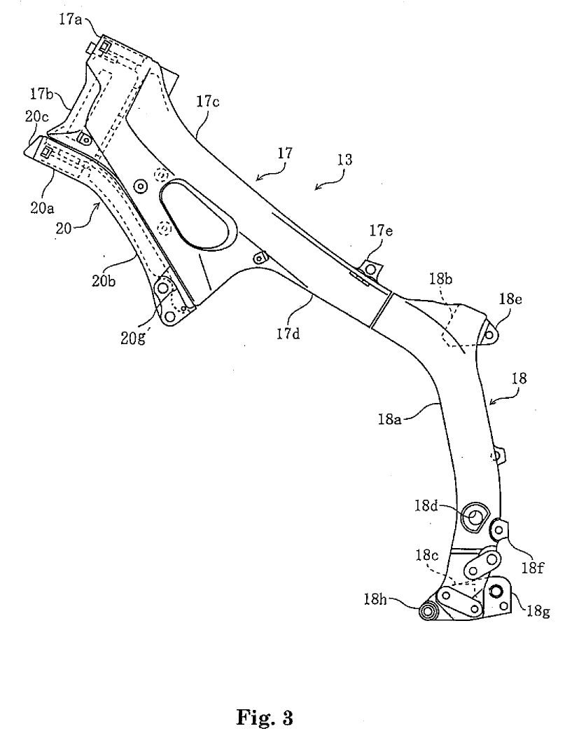

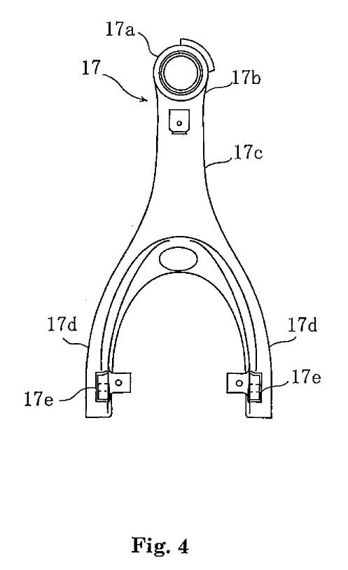

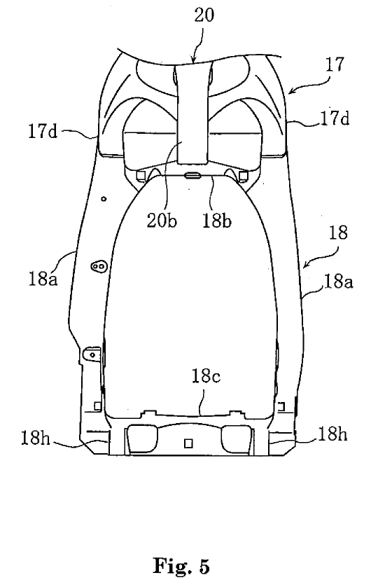

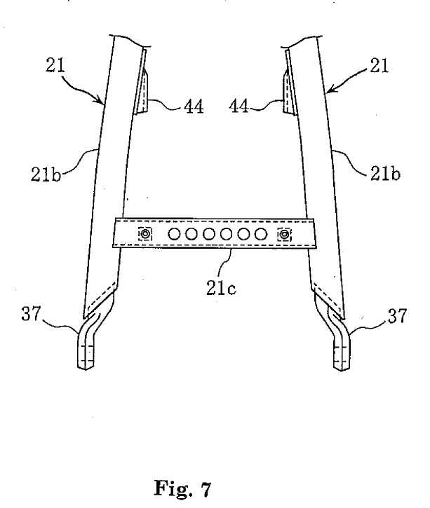

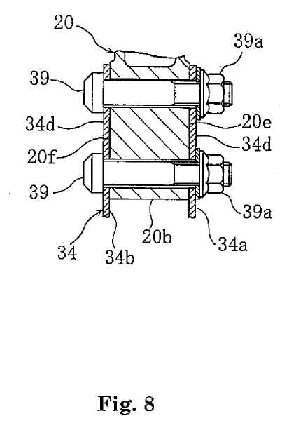

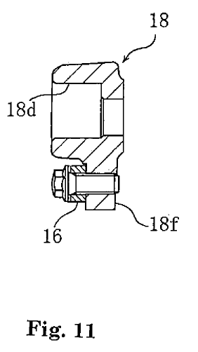

An embodiment of the present invention is now described with reference to the drawings. FIGS. 1-16 illustrate a body frame 2 of a motorcycle 1 and an assembling method of mounting an engine 3 on body frame 2 according to an embodiment of the present invention. Directions such as front, rear, left, and right in the following description are from the perspective of a person sitting on a seat.

Motorcycle 1 is of an off-road type used for a motocross race and includes engine 3 mounted in cradle type body frame 2. A front fork 5 is supported operably in left and right directions by a head pipe 4 at a front end of body frame 2. A rear arm 6 is supported swingably in the vertical direction by a rear lower end of body frame 2. A rear wheel suspension system 7 interposed between rear arm 6 and body frame 2 has a shock absorber 7a, a coil spring 7b and a link mechanism 7c.

A fuel tank 8 is mounted above engine 3 and a seat 9 is mounted behind fuel tank 8. A front wheel 10 is rotatably supported with its shaft by a lower end of front fork 5, and a steering handlebar 11 is fixed on an upper end of front fork 5. A rear wheel 12 is rotatably supported with its shaft by a rear end of rear arm 6.

Engine 3 is a water-cooled four-cycle single-cylinder engine mounted with its cylinder axis directed generally in the vertical direction and has a cylinder block 3b, a cylinder head 3c and a cylinder-head cover 3d joined together in an accumulated manner above a crankcase 3a. Rotational force of engine 3 is transmitted to a rear wheel sprocket 12a of rear wheel 12 via a chain 19.

Body frame 2 has a mainframe 13 extended rearward from head pipe 4 and a down tube 14 positioned under mainframe 13, extended rearward from head pipe 4, and joined to a rear end of mainframe 13. Engine 3 is held and mounted in a space formed by mainframe 13 and down tube 14. In addition, body frame 2 has seat rails 15 at the left and right extended in an obliquely upper rear direction from mainframe 13 to support seat 9, and seat stays 16 at the left and right joining rear ends of seat rails 15 and rear lower ends of mainframe 13.

Mainframe 13 is constituted with a cast part of aluminum alloy, and has a first frame 17 constituting a first section of head pipe 4, and extended in an obliquely lower rear direction from head pipe 4 and second frames 18 extended in a lower direction from a rear end of first frame 17.

First frame 17 has an upper bearing 17a and a pipe main body 17b constituting the first section of head pipe 4, a hollow gusset 17c extended in an obliquely lower rear direction following pipe main body 17b, and upper frames 17d at the left and right extended in an obliquely lower rear direction that is extendedly opened outward in the width direction of the vehicle in continuation of gusset 17c. Upper bearing 17a supports a bearing on an upper side of a steering shaft, and pipe main body 17b is positioned between sections for supporting the upper and lower sides of the steering shaft, and surrounds the steering shaft.

Second frames 18 are integrally joined to rear ends of upper frames 17d at the left and right by welding. Second frames 18 include rear arm brackets 18a at the left and right extended downward in continuation to upper frames 17d, an upper cross frame 18b connecting upper parts of rear arm brackets 18a, and a lower cross frame 18c connecting lower ends thereof. Attaching sections 17e for detachably attaching seat rails 15 are projectingly formed in an upper direction at rear ends of upper frames 17d at the left and right.

Pivot holes 18d supporting a pivot shaft for supporting rear arm 6 with its shaft are coaxially formed in a lower section of rear arm brackets 18a at the left and right, and attaching sections 18f for detachably attaching seat stays 16 are projectingly formed in a rear direction on rear sides of pivot holes 18d. An upper support 18e for supporting an upper end of shock absorber 7a is projectingly provided on upper cross frame 18b in a rear direction, and a lower support 18g for supporting link mechanism 7c is projectingly provided at a lower end of rear arm brackets 18a at the left and right in a rear direction.

Down tube 14 has a first tube 20 constituting a second section of head pipe 4 and extended rearward, and a pair of second tubes 21 at the left and right joining first tube 20 and a lower end of mainframe 13.

First tube 20 is constituted with a forged part of aluminum alloy and has a lower bearing 20a constituting the rest part of head pipe 4 of a part constituted by mainframe 13, and a lower gusset 20b generally in a shape of a square tube extended along a lower edge 17c′ of gusset 17c in continuation to lower bearing 20a. Lower bearing 20a supports a bearing on a lower side of the steering shaft. First tube 20 is integrally joined to pipe main body 17b of first frame 17 and a lower edge of gusset 17c by welding.

A stopper 20c projected forward is integrally formed on a front surface of lower bearing 20a of first tube 20. Steering angles at the left and right of steering handlebar 11 are regulated by stopper 20c. Impact force may be applied to stopper 20c from a side of front fork 5, for example, when steering handlebar 11 is severely hit on a road surface in a case of an overturn. Since stopper 20c is provided on first tube 20 made with a forged part, it can be constituted with sufficient strength to overcome the impact force, thus preventing a crack or the like from occurring in stopper 20c. If stopper 20c is provided on a cast part, a crack may occur in stopper 20c due to impact load during an overturn.

Second tubes 21 at the left and right are constituted with an iron part in a shape of a cylinder and have inclined sections 21a extended downward and expanded outward in the width direction of the vehicle from first tube 20, and horizontal sections 21b extended generally horizontally in a rear direction from lower ends of inclined sections 21a. Rear ends of horizontal sections 21b are connected by a cross member 21c.

Inclined sections 21a of second tubes 21 are detachably joined to first tube 20 via connecting members 33, and horizontal sections 21b are detachably joined to a lower end of rear arm brackets 18a. A structure thereof is described below in detail.

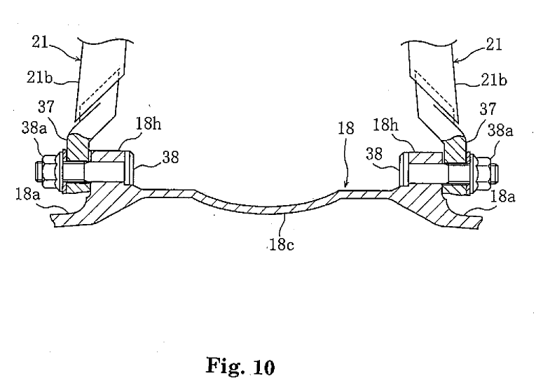

Joint boss members 37 are integrally joined to rear ends of horizontal sections 21b by welding. Bosses (rear ends) 18h are projectingly formed in a front direction on rear ends of rear arm brackets 18a. Joint boss members 37 are disposed outside and overlap bosses 18h at the left and at the right in the width direction of the vehicle (FIG. 10). Joint boss members 37 are detachably fixed on bosses 18h by connecting bolts (connecting members) 38 and nuts 38a.

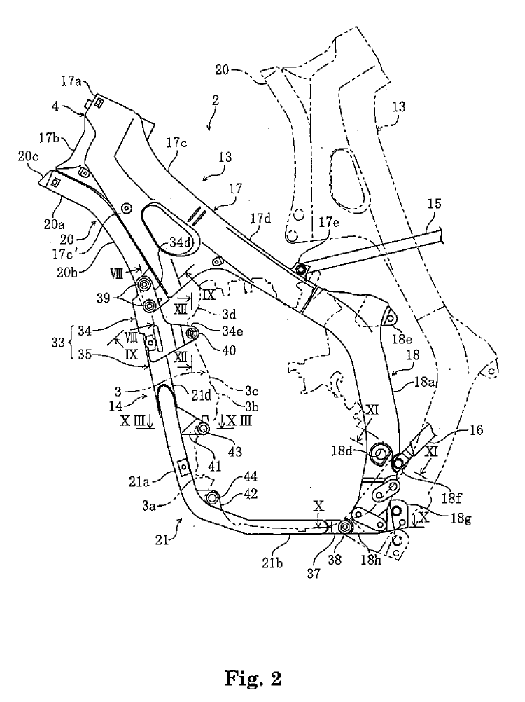

Mainframe 13 and first tube 20 are rotatable in the longitudinal direction around connecting bolts 38 in relation to second tubes 21 by loosening connecting bolts 38 at the left and at the right (FIG. 2).

Second tubes 21 at the left and at the right are joined to first tube 20 by fitting connecting members 33 to first tube 20 and then by fastening a bolt to fix a fitting section. A structure thereof is described below in detail.

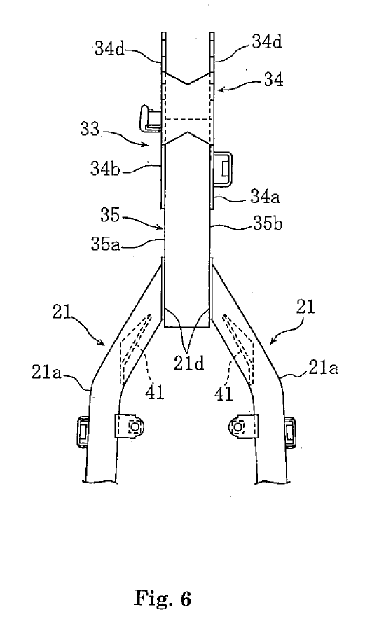

Connecting members 33 have a connecting bracket 34 with a square U-shape in a cross section opened in a rear direction and a square pipe 35 integrally joined to connecting bracket 34 by welding. Front opening edges 21d of second tubes 21 at are integrally joined to left and right walls 35a and 35b of square pipe 35 by welding (FIG. 6).

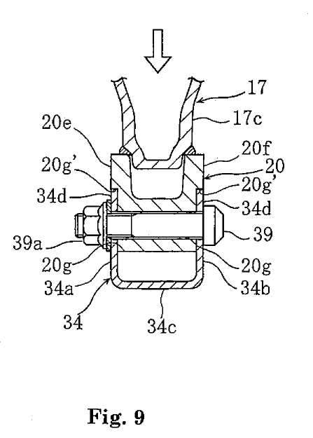

Connecting bracket 34 is made of sheet metal formed by joining lower edges of left and right vertical walls 34a and 34b with a bottom wall 34c (FIG. 9). Vertical walls 34a and 34b have joint sections 34d that extend in an upper direction and supported fitting surfaces 20g formed on left and right walls 20e and 20f of lower gusset 20b of first tube 20.

Positioning shoulders 20g′ are formed on fitting surfaces 20g at the left and right of lower gusset 20b. Upper edges of joint sections 34d of connecting bracket 34 are in contact with positioning shoulders 20g′. Positioning shoulders 20g′ are constituted with a boundary between a machined area and an unmachined area when fitting surfaces 20g are formed by machining a part of left and right walls 20e and 20f. As described above, a positioning section for fixing first tube 20 and second tubes 21 on the joint position is formed.

Joint sections 34d of connecting bracket 34 are detachably fixed on lower gusset 20b of first tube 20 by fastening a pair of connecting bolts 39 with nuts 39a on upper and lower sides.

A footrest 50 on which a rider places a foot is attached to a lower end of each of rear arm brackets 18a at the left and right of body frame 2.

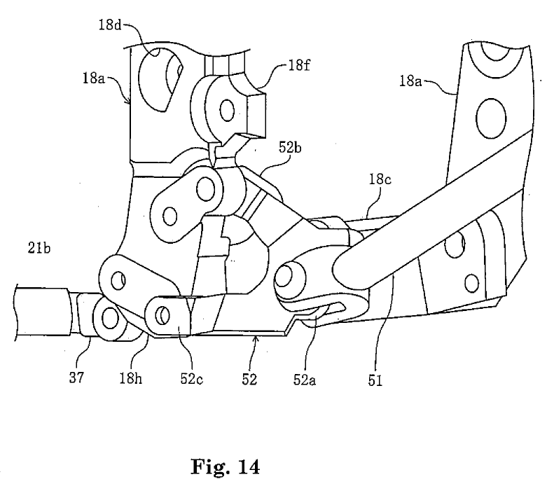

A side stand 51 is supported rotatably between a folded position and a vehicle body supporting position via a stand bracket 52 to the rear of footrest 50 of the left rear arm bracket 18a (see FIGS. 1 and 14). Stand bracket 52 is made of sheet metal and has a support section 52a for supporting side stand 51, an upper attaching section 52b extended generally in a V-shape in a front direction of the vehicle from support section 52a, and a lower attaching section 52c.

Upper attaching section 52b is bent and displaced inward in the width direction of the vehicle from support section 52a and fixed on an inner wall of one of rear arm brackets 18a by fastening a bolt. Lower attaching section 52c is bent and displaced outward in the width direction from support section 52a and fixed on an outer wall of the one of rear arm brackets 18a by fastening a bolt.

Thus, upper and lower attaching sections 52b and 52c extend forward from support section 52a, upper attaching section 52b is fixed on the inner wall of the one of rear arm brackets 18a, and lower attaching section 52c is fixed on the outer wall of the one of rear arm brackets 18a. Accordingly, side stand 51 is compactly disposed on the inner side of the vehicle body in a downsized manner without changing a frame line (a foot area) and is not an obstruction during driving.

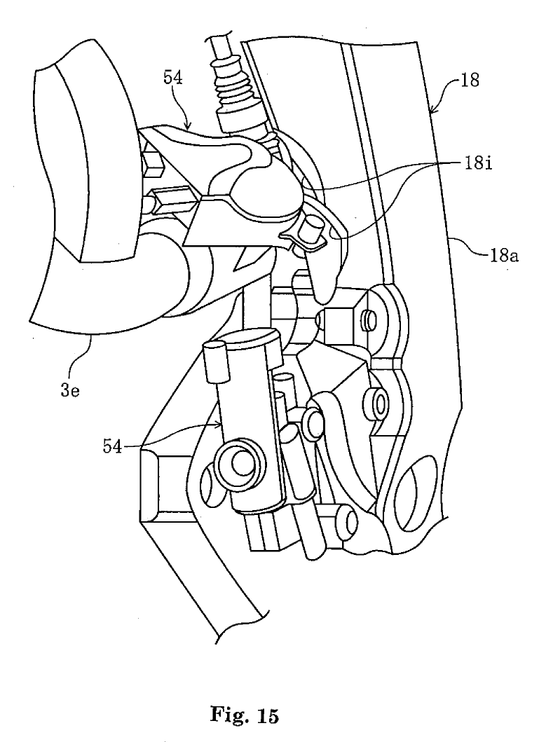

An exhaust pipe 3e of engine 3 is led from a front wall of cylinder head 3c to the right side in the width direction, extended rearward inside one of second frames 18 at the right, and connected to a muffler 53 (FIGS. 1 and 15). An exhaust valve 54 that changes an exhaust emission passage area according to an operating state of the engine is disposed on exhaust pipe 3e in a vicinity of the inside of a right rear arm bracket 18a.

An extra recess 18i is formed on an inner wall of right rear arm bracket 18a, and exhaust pipe 3e and exhaust valve 54 are disposed in extra recess 18i (FIG. 15). Extra recess 18i helps exhaust pipe 3e and exhaust valve 54 to come as close to rear arm bracket 18a as possible without affecting the strength and rigidity of the frame. As a result, exhaust pipe 3e and exhaust valve 54 are efficiently disposed.

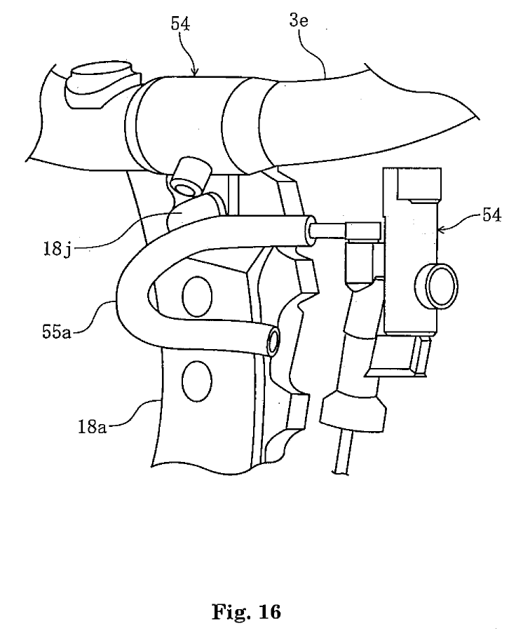

A master cylinder 55 for a rear brake is disposed below exhaust valve 54. A brake hose 55a connected to master cylinder 55 is extended forward from master cylinder 55 and, after making a U-turn, extended rearward (FIG. 16).

An extra recess 18j is formed on an inner wall of one of the rear arm brackets 18a, and brake hose 55a is disposed, passing an inside of extra recess 18j. Consequently, brake hose 55a is efficiently disposed in a vicinity of rear arm bracket 18a.

Engine 3 is, supported by connecting members 33 and second tubes 21 at the left and at the right. A structure thereof is described below in detail.

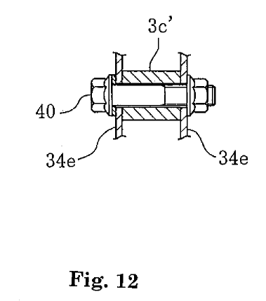

Suspensions 34e extended in a cradle are formed at lower ends of vertical walls 34a and 34b of connecting bracket 34. A boss 3c′ of cylinder head 3c is fixed by fastening a suspension bolt 40 between suspensions 34e (FIGS. 2 and 12).

Upper suspension brackets 41 and lower suspension brackets 42 extended in the cradle are integrally joined by welding to upper sections and lower corners of inclined sections 21a of second tubes 21 at the left and right.

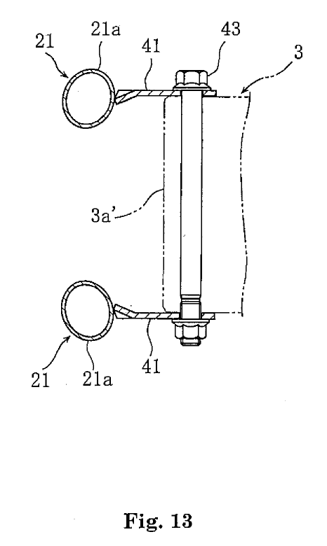

A suspension boss 3a′ of crankcase 3a is fixed between upper and lower suspension brackets 41 and 42 by fastening upper and lower suspension bolts 43 and 44 (FIGS. 2 and 13).

An assembling method of mounting engine 3 on body frame 2 is described hereinafter.

Second tubes 21 are positioned by a jig, and a lower rear end of an assembly of mainframe 13 and first tube 20 is rotatably connected in relation to second tubes 21 by connecting bolts 38. The assembly of mainframe 13 and first tube 20 is then rotated rearward about connecting bolts 38 and, in this state, engine 3 is mounted on second tubes 21 from an upper or lateral side. Engine 3 is fixed on connecting bracket 34 and suspension brackets 41 and 42 by suspension bolts 40, 43 and 44.

Mainframe 13 and first tube 20 are then rotated forward. When mainframe 13 and first tube 20 are rotated forward, positioning shoulders 20g′ of lower gusset 20b of first tube 20 contact upper edges of vertical walls 34a and 34b of connecting bracket 34, and first tube 20 and second tubes 21 are thereby positioned in a joint position. Connecting members 33 of first tube 20 and second tubes 21 are then joined and fixed by connecting bolts 39, and connecting bolts 38 are fastened to join and fix second tubes 21 and mainframe 13.

According to body frame 2 in this embodiment, mainframe 13 comprises upper bearing 17a and pipe main body 17b of head pipe 4 and is extended rearward, and down tube 14 comprises first tube 20 including lower bearing 20a of head pipe 4 and extended rearward, and second tubes 21 detachably joined to first tube 20. Since first tube 20 to which a maximum impact force from a road surface is applied is made with a forged part of aluminum alloy and mainframe 13 is made with a cast part of aluminum alloy, strength and rigidity of body frame 2 is secured against input from a road surface and increased cost is suppressed.

Further, since second tubes 21 are detachable from first tube 20, material for second tubes 21 can be freely selected. Consequently, sufficient strength and rigidity can be secured and material cost suppressed by adopting second tubes 21 made with an iron part in a shape of a cylinder.

According to this embodiment, connecting members 33 having a square U-shape in a cross section are integrally joined to second tubes 21 by welding, and connecting members 33 and first tube 20 are connected by connecting bolts 39. Consequently, second tubes 21 and first tube 20 can be made with different materials and can be firmly connected with a simple structure.

According to this embodiment, a positioning section for positioning first tube 20 and second tubes 21 in a joint position is provided between connecting members 33 and first tube 20. Consequently, joint accuracy when second tubes 21 are detachably joined to first tube 20 is secured, and the work of joining second tubes 21 is easily performed.

Positioning shoulders 20g′ comprising the positioning section are constituted with a boundary between a machined area and an unmachined area when fitting surfaces 20g are formed by machining a part of left and right walls 20e and 20f. Consequently, the work of forming positioning shoulders 20g′ is extremely easy.

According to this embodiment, second tubes 21 are detachably joined to the lower ends of rear arm brackets 18a. Consequently, second tubes 21 and rear arm brackets 18a are firmly joined in a simple structure.

According to this embodiment, mainframe 13 is equipped with first frame 17 having upper bearing 17a, pipe main body 17b of the head pipe, gusset 17c and upper frames 17d, and with second frames 18 having rear arm brackets 18a connecting first frame 17 and second tubes 21. Consequently, the weight of body frame 2 as a whole is reduced while necessary strength and rigidity is secured.

Since first frame 17 and second frames 18 are integrally joined by welding, strength and rigidity necessary for mainframe 13 is secured.

According to this embodiment, when engine 3 is mounted on body frame 2, mainframe 13 is rotatably connected to second tubes 21 via connecting bolts 38, mainframe 13 and first tube 20 are rotated rearward about connecting bolts 38, engine 3 is mounted and fixed on second tubes 21 in this state, mainframe 13 and first tube 20 are then rotated forward, first tube 20 and second tubes 21 are joined and fixed, and second tubes 21 and mainframe 13 are joined and fixed by connecting bolts 38. Consequently, assembling performance of engine 3 is enhanced and body frame 2 is downsized.

By contrast, when a mainframe and first and second tubes are joined in advance by welding, a relatively large space between the body frame and engine must be provided to mount the engine on the body frame. Accordingly, there is a problem in that the body frame is enlarged.

According to the invention made in view of these drawbacks, engine 3 is mounted with mainframe 13 opened in a rear direction in relation to second tubes 21. Consequently, the space between body frame 2 and engine 3 is minimized and body frame 2 is downsized as a whole.

1. A body frame of a motorcycle, comprising:
a mainframe extended rearward from a head pipe; and
a down tube positioned under the mainframe, extended rearward from the head pipe, and joined to a rear end of the mainframe,
wherein the mainframe comprises a first section of the head pipe and is extended rearward,
the down tube includes a first tube comprising a second section of the head pipe and extended rearward, and a second tube joining the first tube and the rear end of the mainframe,
the first tube is joined to the mainframe by welding, and
the second tube is detachably joined to the first tube.

2. The body frame of a motorcycle according to claim 1, wherein the first section includes an upper bearing.

3. The body frame of a motorcycle according to claim 1, wherein the second section includes a lower bearing.

4. The body frame of a motorcycle according to claim 1, wherein
the mainframe comprises a cast part, and
the first tube of the down tube comprises a forged part.

5. The body frame of a motorcycle according to claim 4, wherein the second tube comprises an iron part.

6. The body frame of a motorcycle according to claim 1, wherein
the second tube has a connecting member with a square U-shape in a cross section, and
the second tube is detachably joined to the first tube by fitting the connecting member and the first tube.

7. The body frame of a motorcycle according to claim 6, wherein a positioning section for positioning the first tube and the second tube on a joint position is formed between the connecting member and the first tube.

8. The body frame of a motorcycle according to claim 7, wherein the positioning section comprises a shoulder formed on the first tube in contact with an edge of the connecting member.

9. The body frame of a motorcycle according to claim 1, wherein the second tubes is detachably joined to the rear end of the mainframe.

10. The body frame of a motorcycle according to claim 1, wherein the mainframe includes:
a first frame comprising a part of the first section of the head pipe and extended rearward; and
a second frame connecting the first frame and the second tube.

11. The body frame of a motorcycle according to claim 10, wherein the first frame and the second frame are joined by welding.

12. An assembling method of mounting an engine on a body frame of a motorcycle having a mainframe extended rearward from a head pipe; and a down tube including a first tube positioned under the mainframe and extended rearward from the head pipe and a second tube joining the first tube and a rear end of the mainframe, in which the first tube is joined to the mainframe by welding, and the second tubes are detachably joined to the first tube, comprising:
rotatably connecting the rear end of the mainframe to the second tubes by a connecting member;
rotating the mainframe and the first tube rearward about the connecting member;
mounting the engine on the second tubes;
rotating the mainframe and the first tube forward;
joining and fixing the first tube and the second tube; and
fixing a connecting section between the second tube and the mainframe.

13. The assembling method according to claim 12, wherein the second tube has a connecting member with a square U-shape in a cross section, and further comprising:
fitting the first tube in the connecting member by rotating the mainframe and the first tube forward; and
joining and fixing the first tube on the second tube via the connecting member.

14. The assembling method according to claim 13, wherein a positioning section is formed between the connecting member and the first tube, and further comprising:
rotating the mainframe and the first tube forward so that the first tube is positioned in relation to the connecting member by the positioning section; and
joining and fixing the first tube on the second tube via the connecting member.

15. A motorcycle provided with a body frame comprising:
a mainframe extended rearward from a head pipe; and
a down tube positioned under the mainframe, extended rearward from the head pipe, and joined to a rear end of the mainframe; wherein
the mainframe constitutes a first section of the head pipe and is extended rearward,
the down tube includes a first tube comprising a second section of the head pipe and extended rearward and a second tube joining the first tube and the rear end of the mainframe,
the first tube is joined to the mainframe by welding, and
the second tubes is detachably joined to the first tube.
